(19) United States
(12) Patent Application Publication
(10) Pub. No.: US 2015/0367960 A1
(43) Pub. Date: Dec. 24, 2015

(54) SYSTEM AND METHOD FOR VEHICLE POSITIONING

(71) Applicants: Jeffrey DYANZIO, Shillington, PA (US); John ANDREWS, Sun Prairie, WI (US)

(72) Inventors: Jeffrey DYANZIO, Shillington, PA (US); John ANDREWS, Sun Prairie, WI (US)

(21) Appl. No.: 14/748,661

(22) Filed: Jun. 24, 2015

Related U.S. Application Data
(60) Provisional application No. 62/016,247, filed on Jun. 24, 2014.

(51) Int. Cl. B64F 1/22; G05D 1/02

(52) U.S. Cl. CPC B64F 1/228; G05D 1/0212; G05D 1/0246; G05D 1/0234; G05D 1/028

(57) ABSTRACT

Provided are a system and method for vehicle positioning. The system includes a control module, at least one sensor arranged and disposed to measure operational parameter and provide the operational parameters to the control module, and a ground transport vehicle in communication with the control module. The ground transport vehicle is arranged and disposed for coupling with an aircraft and the control module is arranged and disposed to direct at least one of ground handling of the aircraft and storage of the aircraft. The method includes providing a system, coupling a ground transport vehicle to an aircraft, communicating operational parameters from at least one sensor to a control module, defining an operational area for the aircraft, setting a ground transportation route with the control module based upon the operational parameters from the at least one sensor, and moving the aircraft along the ground transportation route with the ground transport vehicle.

### CROSS-REFERENCE TO RELATED APPLICATIONS

This application claims the benefit of and priority to U.S. Provisional Patent Application No. 62/016,247 filed on Jun. 24, 2014, which is hereby incorporated by reference in its entirety.

### FIELD OF THE INVENTION

The present invention is directed toward a system and a method for vehicle positioning. More specifically, the present invention is directed to a system and a method for aircraft positioning.

### BACKGROUND OF THE INVENTION

Aircrafts are ground handled and/or stored between flights. Current ground handling and storage methods/devices include internal combustion tow vehicles, battery powered tow vehicles, and remote control tow vehicles. Often, these storage methods and devices include various risks that may cause damage to the aircraft.

One common method of handling and storing aircrafts between flights includes towing the aircrafts with a tow vehicle. The aircraft is manually attached to the tow vehicle and operation is based upon visual observations made by the tow vehicle operator or other handling/storage personnel. The visual observation based handling/storage presents various risks that may cause damage to the aircrafts. Specifically, without other safeguards in place, human error during handling and/or storage frequently results in damage to the aircrafts.

A system and method with improvements in the process and/or the properties of the components formed would be desirable in the art.

### BRIEF DESCRIPTION OF THE INVENTION

In one exemplary embodiment, a system includes a control module, at least one sensor arranged and disposed to measure operational parameter and provide the operational parameters to the control module, and a ground transport vehicle in communication with the control module. The ground transport vehicle is arranged and disposed for coupling with an aircraft and the control module is arranged and disposed to direct at least one of ground handling of the aircraft and storage of the aircraft.

In another exemplary embodiment, a system includes a control module, at least one sensor arranged and disposed to measure operational parameter and provide the operational parameters to the control module, at least one marker arranged and disposed for detection by the at least one sensor, a ground transport vehicle in communication with the control module, and a kill system secured to the ground transport vehicle. The ground transport vehicle is arranged and disposed for coupling with an aircraft, the control module is arranged and disposed to direct at least one of ground handling of the aircraft and storage of the aircraft, and the kill system is arranged and disposed to disable movement of the ground transport vehicle.

In another embodiment, a ground transport and storage method includes providing a system, the system including a control module, at least one sensor arranged and disposed to measure operational parameter and provide the operational parameters to the control module, and a ground transport vehicle in communication with the control module, coupling the ground transport vehicle to an aircraft, communicating the operational parameters from the at least one sensor to the control module, defining an operational area for the aircraft, setting a ground transportation route with the control module based upon the operational parameters from the at least one sensor, and moving the aircraft with the ground transport vehicle. The moving of the aircraft follows the ground transportation route.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of aircrafts and a tow vehicle in a storage facility, according to an embodiment of the disclosure.

FIG. 2 illustrates a schematic view of a system for positioning an aircraft, according to an embodiment of the disclosure.

FIG. 3a illustrates a front view of a tow hitch, according to an embodiment of the disclosure.

FIG. 3b illustrates a side view of the tow hitch of FIG. 3a.

FIG. 3c illustrates a bottom view of the tow hitch of FIG. 3a.

FIG. 4 illustrates a schematic view of a virtual collision avoidance module, according to an embodiment of the disclosure.

Wherever possible, the same reference numbers will be used throughout the drawings to represent the same parts.

### DETAILED DESCRIPTION OF THE INVENTION

Provided are a system and a method for reducing or eliminating damage to an aircraft during ground handling and/or storage. Embodiments of the present disclosure, in comparison to articles and methods not using one or more of the features disclosed herein, increase adherence to aviation ground handling safety procedures, increase procedural adherence without changing how aircrafts are moved, increase ground handling and storage safety, decrease aircraft damage, decrease aircraft collision during ground handling, increase personnel security, increase aircraft storage efficiency, or a combination thereof.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

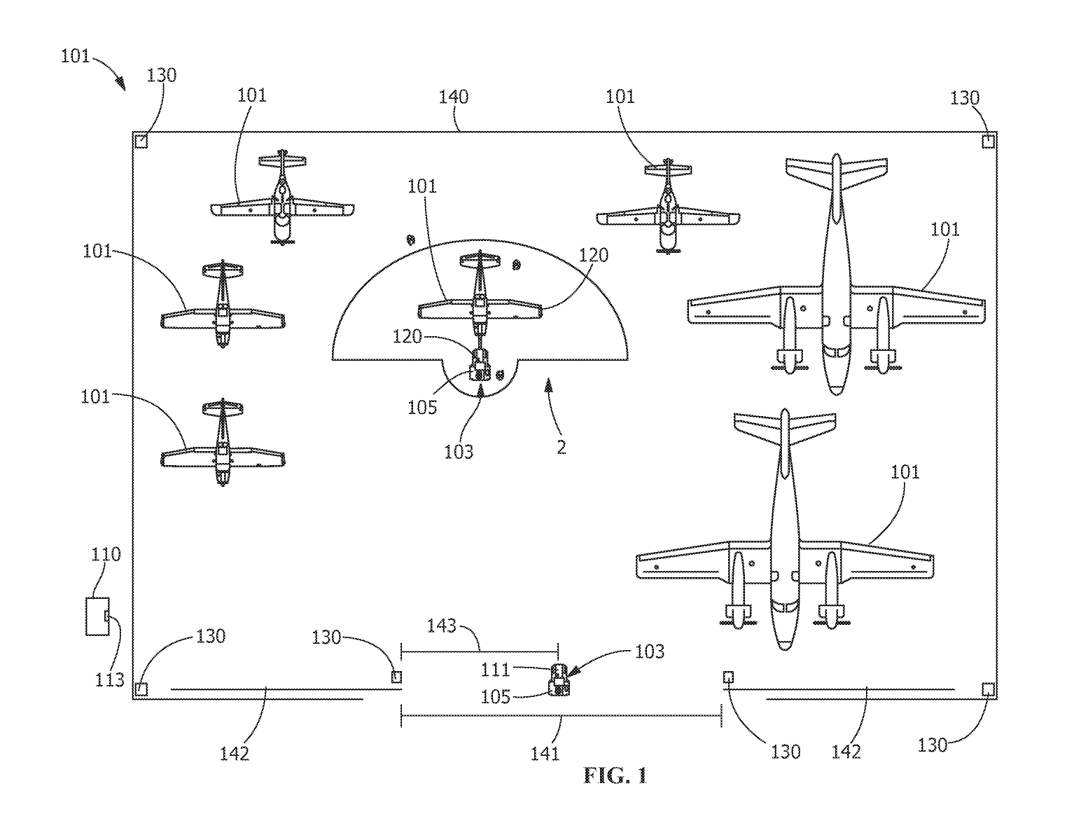

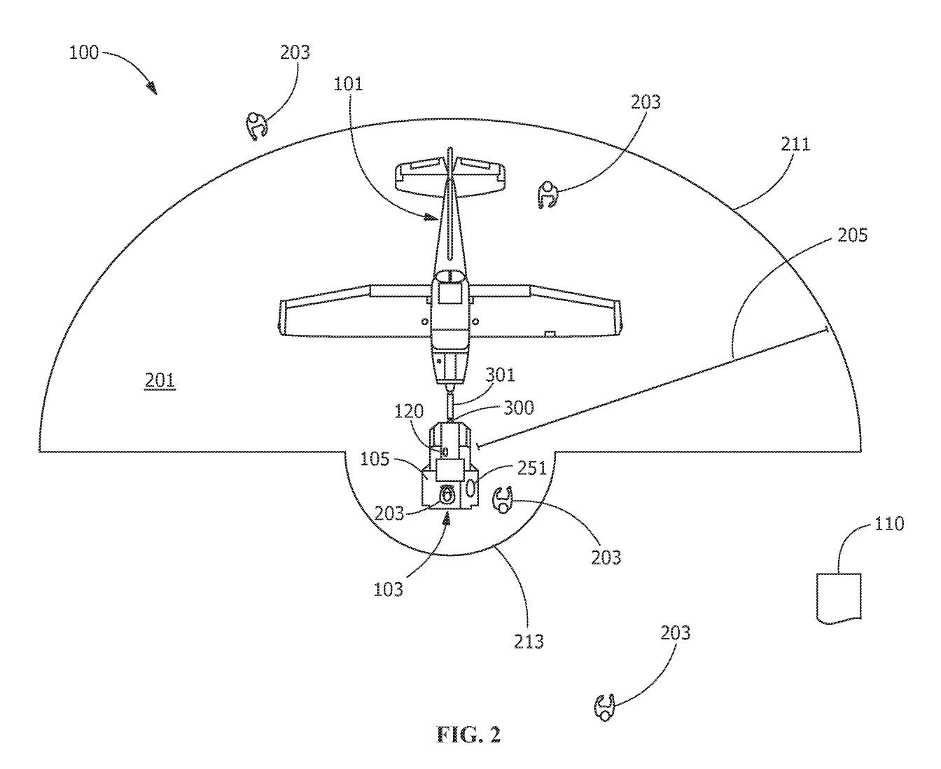

FIGS. 1-2 illustrate a system 100 arranged and disposed for ground handling and/or storage of one or more aircrafts 101. The system 100 is designed to be universal, facilitating easy installation of one or more system components onto any ground transport vehicle 103 and/or aircraft 101, by any person(s) with basic mechanical knowledge. According to one or more of the embodiments disclosed herein, the system 100 provides electronic support to human operation. Additionally, the system 100 increases operator/owner safety, decreases or eliminates damage and/or loss to the one or more aircrafts, decreases insurance costs, or a combination thereof. Although described herein with regard to aircraft operations, as will be appreciated by those skilled in the art, the system is not so limited and may be used for storage and handling of any other vehicle or movable article.

In one embodiment, the system 100 includes a control module 110 and at least one sensor 120. Each of the sensors 120 is positioned within a storage facility 140, such as a hangar, secured to one or more of the aircrafts 101, secured to the one or more of the ground transport vehicles 103, or a combination thereof. Additionally, each of the sensors 120 is configured to measure and/or determine one or more operational parameters, and communicate the one or more operational parameters to the control module 110. For example, the at least one sensor 120 may be configured to measure environmental conditions, such as topography, transport speed, transport direction, or a combination thereof. Other operational parameters measured and/or determined by the sensor(s) 120 include, but are not limited to, location of the storage facility 140, a position of a hangar door 142, a height of the storage facility 140, a width of the storage facility 140, a height of the aircraft 101, a width of the aircraft 101, or a combination thereof.

Suitable sensors include, but are not limited to, motion sensors, proximity sensors, velocity sensors, laser topography sensors, a counting switch, or a combination thereof. Additionally or alternatively, the at least one sensor 120 may be configured to detect one or more markers 130 and/or receive information from the one or more markers 130. The one or more markers 130 includes any suitable marker, such as, but not limited to, a fixed positional marker, a radio-frequency identification (RFID) tag, microchips, or a combination thereof. In certain embodiments, the system 100 is configured to set one or more portions of the storage facility 140 as the marker(s) 130. Using the one or more portions of the storage facility 140 as markers 130, the system 100 determines whether the aircraft 101 and/or the ground transport vehicle 103 is within the storage facility 140, and if so, determine a location of the aircraft 101 and/or the ground transport vehicle 103. The fixed points and/or the markers 130 may also be configured to identify the storage facility 140 itself, providing dimensions and/or other parameters of the storage facility 140 and decreasing risk during movement and storage.

The sensors 120 are electrically and/or wirelessly coupled to the control module 110, the electrical or wireless coupling facilitating communication of the one or more operational parameters from the sensor(s) 120 to the control module 110. In one embodiment, each of the at least one sensors 120 wirelessly transmits the one or more operational parameters directly to the control module 110. In another embodiment, at least one of the sensors 120 is electrically coupled to a transmitter 111 that is arranged and disposed to electrically and/or wirelessly communicate with the control module 110. The transmitter 111 includes any device suitable for communicating the one or more operational parameters from the sensor(s) 120, increasing a signal strength from the sensor(s) 120, providing increased communicability with the control module 110, or a combination thereof. In a further embodiment, a receiver 113 is electrically and/or wirelessly coupled to the control module 110, the receiver 113 being arranged and disposed to communicate with the sensor(s) 120 and/or the transmitter 111. For example, one or more of the sensors 120 may be electrically coupled to the transmitter 111, which wirelessly communicates with the receiver 113 that is electrically coupled to the control module 110. Alternatively, the sensor(s) 120 may wirelessly communicate with the transmitter 111, which is positioned within the storage facility 140 and electrically coupled to the receiver 113, which is positioned outside the storage facility 140 and in wireless communication with the control module 110. In certain embodiments, the transmitter 111 and/or the receiver 113 facilitate communication between the sensor(s) 120 and the control module 110 when direct communication therebetween is difficult, restricted, and/or unreliable.

In one embodiment, the control module 110 communicates with one or more of the ground transport vehicles 103. The ground transport vehicles 103 include any vehicle involved with and/or used in close proximity to the ground transport and/or storage of the one or more aircrafts 101. Suitable ground transport vehicles 103 include, but are not limited to, tow vehicles 105, cargo vehicles, refueling vehicles, maintenance vehicles, or a combination thereof. In another embodiment, the control module 110 provides usage commands to the ground transport vehicle(s) 103. The usage commands are generated by the control module 110 based upon the one or more operational parameters measured and/or determined by the sensor(s) 120, guide movement of the ground transport vehicle(s) 103, decrease or eliminate damage to the one or more aircrafts 101 during ground transport and/or storage, or a combination thereof.

Additionally or alternatively, the system 100 includes a kill system 150 secured to the ground transport vehicle 103. The kill system 150 is arranged and disposed to disable operation and/or movement of the ground transport vehicle 103. In one embodiment, the kill system 150 disables operation and/or movement of the ground transport vehicle 103 by activating a braking system 251 (see FIG. 2) and/or cutting power to the ground transport vehicle 103. The kill system 150 may be activated remotely by the control module 110 and/or manually by a certified individual 203 with physical or remote access to the ground transport vehicle 103. For example, the control module 110 may activate the kill system 150 when a possible collision is detected based upon the operational parameters received from the sensor(s) 120. In another example, the kill system 150 is activated by the individual 203 operating the ground transport vehicle 103, the individual 203 acting as a spotter, the individual 203 acting as a local or remote manager, any other certified individual 203, and/or the control module 110 during events such as, but not limited to, incapacitation of the driver, loss of visual or auditory communication with a spotter, loss of control of the vehicle 103 and/or the aircraft 101, or a combination thereof.

Under certain operating conditions, such as during periods of no activity and/or during period when no aircrafts 101 are coupled to the ground transport vehicle(s) 103, the system 100 is configured to enter a standby mode. In the standby mode, the control module 110 is configured to receive communication from the sensor(s) 120 without providing usage commands to the ground transport vehicle(s) 103. Upon receiving an initialization signal from one or more of the sensor(s) 120, the system 100 leaves the standby mode and enters an operational mode. The initialization signal from the sensor(s) 120 includes any suitable signal indicating a predetermined type of activity, such as, but not limited to, detection of an unauthorized individual (e.g., through RFID tags), movement of one or more aircrafts 101, coupling of one or more of the aircrafts 101 to the ground transport vehicle(s) 103, detection of a possible collision, or a combination thereof.

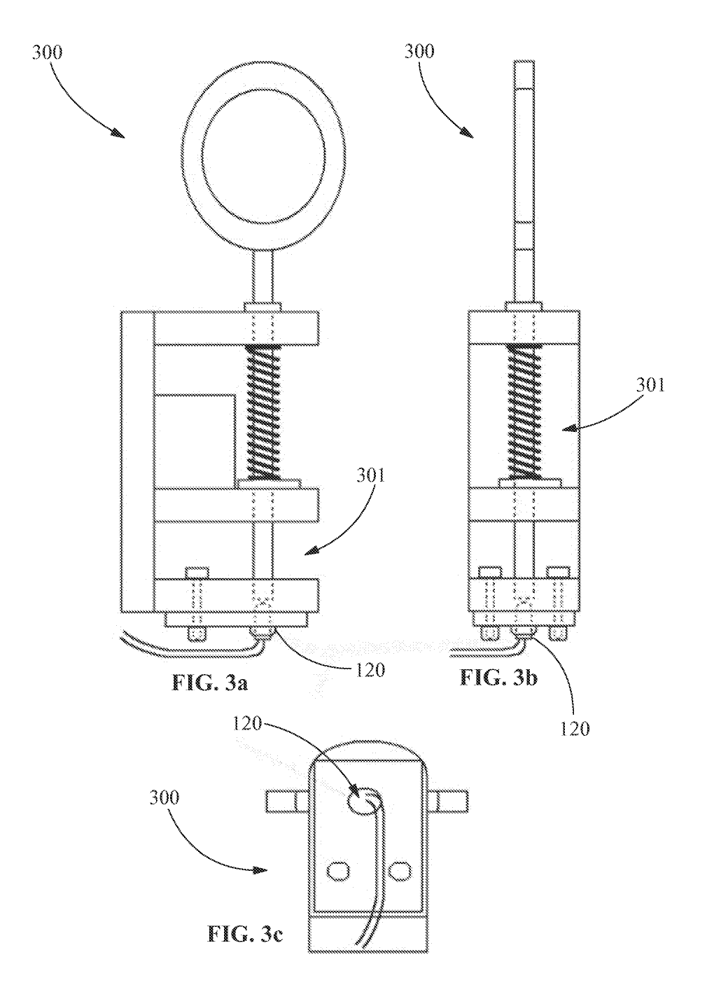

For example, in one embodiment, one or more of the sensors 120 are configured to detect coupling of a tow member 303 to a hitch 300 or other attachment member on the ground transport vehicle(s) 103, and generate the initialization signal in response thereto. The tow member 303 is detachably secured to the aircraft 101, and includes any suitable coupling member, such as, but not limited to, a tow bar and/or tow head. The hitch 300 is integral with and/or secured to the ground transport vehicle(s) 103, and as illustrated in FIG. 3, includes a receiving portion 301 arranged and disposed to receive the tow member 303 therein. In another embodiment, one or more of the sensors 120, such as a proximity sensor, is positioned to detect the insertion of an element, such as the tow member 303, within the receiving portion 301. Upon detection of the tow member 303 within the receiving portion 301, the sensor(s) 120 generate the initialization signal and the system 100 enters the operational mode. In a further embodiment, one or more of the markers 130 is secured to the aircraft 101, the ground transport vehicle(s) 103, the hitch 300, and/or the tow member 303. When the sensor(s) 120 detects the element within the receiving portion 301 the system 100 searches for one or more of the markers 130 before generating the initialization signal. By searching for the marker(s) 130 prior to generating the initialization signal, the system 100 reduces or eliminates accidental initialization of the control module 101 from foreign objects, such as, but not limited to, debris, an individual reaching into the attachment point, or a combination thereof. Additionally or alternatively, the hitch 300 includes a switch configured to mechanically or electronically activate the system 300, such as, for example, when the ground transport vehicle 103 is coupled to the aircraft 101 without the tow member 303.

In certain embodiments, the one or more markers 130 are secured to other objects and/or articles, including, but not limited to, individuals 203, such as a vehicle operators, supervisors, wing walkers, or other authorized personnel, the hangar doors 142 (see FIG. 1), any other suitable object or article, or a combination thereof. The marker(s) 130 are secured to the other objects and/or articles through any suitable securing method, such as, but not limited to, an adjustable backing, a pliable housing, adhesives, fasteners, clips, screws, magnets, or a combination thereof. In one embodiment, the sensor(s) 120 are configured to generate the initialization signal upon detection and/or movement of any of the one or more markers 130 near or within an operational area 201 of the aircraft 101 (see FIG. 2) and/or the storage facility 140. For example, in another embodiment, the sensor(s) 120 are configured to generate the initialization signal upon detection of the marker(s) 130 secured to the individual 203 within the operational area 201. In a further embodiment, the sensor(s) 120 are configured to generate the initialization signal upon opening of the hangar doors 142 and/or opening of the hangar doors 142 to a predetermined distance.

Additionally or alternatively, the system 100 may be configured to generate an alert and/or disable one or more of the ground transport vehicle(s) 103 and/or the aircrafts 101 based upon the detection of the one or more markers 130 by the sensor(s) 120. For example, in one embodiment, the system 100 is configured to disable the ground transport vehicle(s) 103 upon detection of incompatible equipments, such as, but not limited to, the detection of an improper tow member 303 coupled to the aircraft 101, as determined by the one or more markers 130 on the tow member 303 and/or the aircraft 101. In another embodiment, the system 100 is configured to detect one or more of the individuals 203 within the operational area 201 based upon the one or more marker 130 worn and/or carried by the individuals 203. In a further embodiment, the system 100 determines whether the individuals 203 are certified and/or in proper position. For example, each of the one or more markers 130 may be configured to provide specific operational privileges, such as, but not limited to, driver, wing walker, trainer, manager, spotter, or a combination thereof. Upon detection of one or more individuals 203 that are not certified or are not in proper position, the system 100 generates the alert and/or disables the ground transport vehicle(s) 103 and/or the aircrafts 101.

The alert includes any alert configured to be heard and/or seen by the individual 203 operating the tow vehicle 105, a wing walked, any other individual in proximity to the aircraft 101 and/or vehicle 103 being moved, or a combination thereof. Suitable alerts include, but are not limited to, visual and/or audible alerts, such as lights and/or sirens, in the storage facility 140, on the tow vehicle 105, on the aircraft 101, or a combination thereof. In one embodiment, the system 100 is electronically or otherwise coupled to an emergency alert system, such as, but not limited to, a fire warning system, a fire suppression system, a security system, an emergency response system, or a combination thereof. In another embodiment, the system 100 is configured to activate the emergency alert system upon determining the presence of one or more predetermined operational parameters, and/or to disable the vehicle(s) 103, aircraft(s) 101, and/or other features of the system 100 in response to the emergency alert system being activated. The system 100 may also be configured to notify managers, supervisors, and/or other individuals 203 of any emergency alert system activation, such as through automated messages or telephone calls.

When each of the individuals 203 is involved in one or more of the operations indicated by the marker(s) 130, the system 100 permits the ground transport to proceed. For example, when the individual 203 certified as a driver is detected in the ground transportation vehicle 103, and the individual(s) 203 certified as wing walkers and/or spotters are detected in their proper position within the operational area 201, the system 100 permits the operation to proceed. However, when one or more of the individuals 203 is present in the operational area 201 without the marker(s) 130 and/or a manager, engages in an operation not supported by the one or more markers 130, and/or is detected as being out of position, the system 100 disables one or more features thereof.

In one embodiment, after entering the operational mode the system 100 begins an internal time delay. The internal time delay provides the individuals 203 time to set-up for the operation, inspect the surrounding area prior to starting movement, inspect the vehicle 103, and/or inspect the aircraft 101. In another embodiment, as illustrated in FIG. 2, after coupling the tow member 303 and/or the aircraft 101 to the hitch 300 and/or the ground transport vehicle 103, the system 100 defines the operational area 201 for the aircraft 101 involved in the movement. The operational area 201 is defined by any suitable method for surrounding the aircraft 101 and/or the ground transport vehicle 103. For example, the control module 110 may define the operational area 201 based upon the operating parameters received from the sensor(s) 120. In another example, one or more of the markers 130 on the aircraft 101 are configured to provide the control module 110 with information regarding length, width, and/or height of the aircraft 101. Additionally or alternatively, the control module 110 may include an input device configured to receive user input, facilitating user creation and/or modification of the operational area 201. Suitable input devices include any device capable of receiving user input, such as, but not limited to, a key pad, a touch screen, voice recognition, or a combination thereof.

The operational area 201 includes any suitable shape and/or geometry corresponding to the aircraft 101 and/or ground transport vehicle 103 identified in the movement. In one embodiment, the operational area 201 includes a first semi-circular portion 211 corresponding to the aircraft 101 and a second semi-circular portion 213 corresponding to the tow vehicle 105. In another embodiment, the first semi-circular portion 211 is determined based upon the shape and/or size of the aircraft 101, and the second semi-circular portion 213 is assigned based upon the tow vehicle 105 being used. In a further embodiment, a first radius 205 of the first semi-circular portion 211 is assigned by the control module 100 based upon a length of the aircraft 101 involved in the movement. The first radius 205 is selected to extend away from the tow vehicle 105 with a length that is greater than the length of the aircraft 101, forming the first semi-circular portion 211 arranged and disposed to contain any movement of the aircraft 101 therein. By selecting the first radius 205 based upon the length of the aircraft 101, the system 100 is configured to define larger operational areas 201 for larger aircrafts 101. Although shown as two separate semi-circular portions, as will be appreciated by those skilled in the art, the operational area 201 is not so limited, and may include any other suitable shape and/or geometry, such as, but not limited to, circular, substantially circular, square, rectangular, triangular, uniform, irregular, or a combination thereof.

In certain embodiments, when a specific aircraft 101 is not identified in the movement, the system 100 sets the operational area 201 to a default/universal size. In another embodiment, setting the operational area 201 to the default/universal size permits all or substantially all aircraft 101 that are not part of the system 100 to be used without first determining the parameters of the particular aircraft 101. For example, the default/universal size may be configured to accommodate the largest possible aircraft, which provides a virtual perimeter and/or aircraft parameters suitable for use with smaller aircraft as well. As will be appreciated by those skilled in the art, while the default/universal size is suitable for use with small aircraft, the movement of smaller aircraft using the default/universal size may result in large open spaces and/or reduced storage efficiency within the storage facility 140. To reduce the large open spaces and/or reduced storage efficiency, in a further embodiment, the default/universal size is adjusted and/or a user defined size is generated through user input to the input device.

During ground transportation and/or storage, the operational area 201 moves with the aircraft 101 and/or the ground transport vehicle 103. As the aircraft 101 is moved by the ground transport vehicle 103, the system 100 detects any objects that are adjacent to and/or enter the operational area 201. For example, based upon the sensors 120 and/or markers 130, the system 100 detects other individuals 203, other aircrafts 101, other ground transport vehicles 103, the hangar 140, the hangar doors 142, or a combination thereof. Upon detection of an object within the operational area 201, the system 100 is configured to generate an alert and/or disable the ground transport vehicle 103. By generating the alert and/or disabling the ground transport vehicle 103, the system 100 decreases or eliminate collision of the aircraft 101 with the hangar 140, other aircrafts 101, other ground transport vehicles 103, individuals 203, and/or any other objects present during ground transportation and storage.

In one embodiment, the system 100 generates tail clearance and/or wing clearance parameters for the aircraft 101, and selects the storage facility 140 for the aircrafts 101 based upon the generated parameters. In another embodiment, the system 100 is configured to determine whether the hangar doors 142 are open or closed, and if open, a width 141 of the opening. In a further embodiment, the system 100 is configured to limit aircraft movement if the width 141 of the opening between the hangar doors 142 is not equal to or greater than the generated wing and/or tail clearance parameters of the aircraft 101. For example, the system 100 may determine a proximity 143 of the tow vehicle 105 to the hangar door 142, and if the proximity 143 is with a half wingspan plus buffer distance of the aircraft 101, the system 100 indicates an unsafe condition and disables movement of the tow vehicle 105 into the storage facility 140. Additionally or alternatively, the system 100 sets minimum lighting requirements for transportation and storage. The one or more sensors 120 may include light sensors configured to determine the amount of lumens within the storage facility 140. When the amount of lumens is below the minimum lighting requirements, the system 100 may automatically adjust the lighting within the storage facility 140 and/or suspend the operation until the minimum lighting requirements have been met.

One or more of the sensors 120 additionally or alternatively includes a camera secured to the vehicle 103 and/or the aircraft 101. The camera is configured to record the movements and/or create a video backup of the movements, and may be manually or automatically activated. For example, the system 100 may activate the camera upon identifying that a movement is taking place and/or one of the individuals 203 may manually activate the camera before movement begins. In one embodiment, the camera is coupled to a display, such as a screen positioned on the vehicle 103, providing real-time video of the movement recorded by the camera. In another embodiment, one or more of the cameras facilitate remote wing walking during the movement by managers or other predetermined individuals having an ability to activate the kill system 150. Additionally or alternatively, the screen may display pending conditions throughout the movement, providing the individual 203 operating the vehicle 103 with real-time information regarding operational parameters.

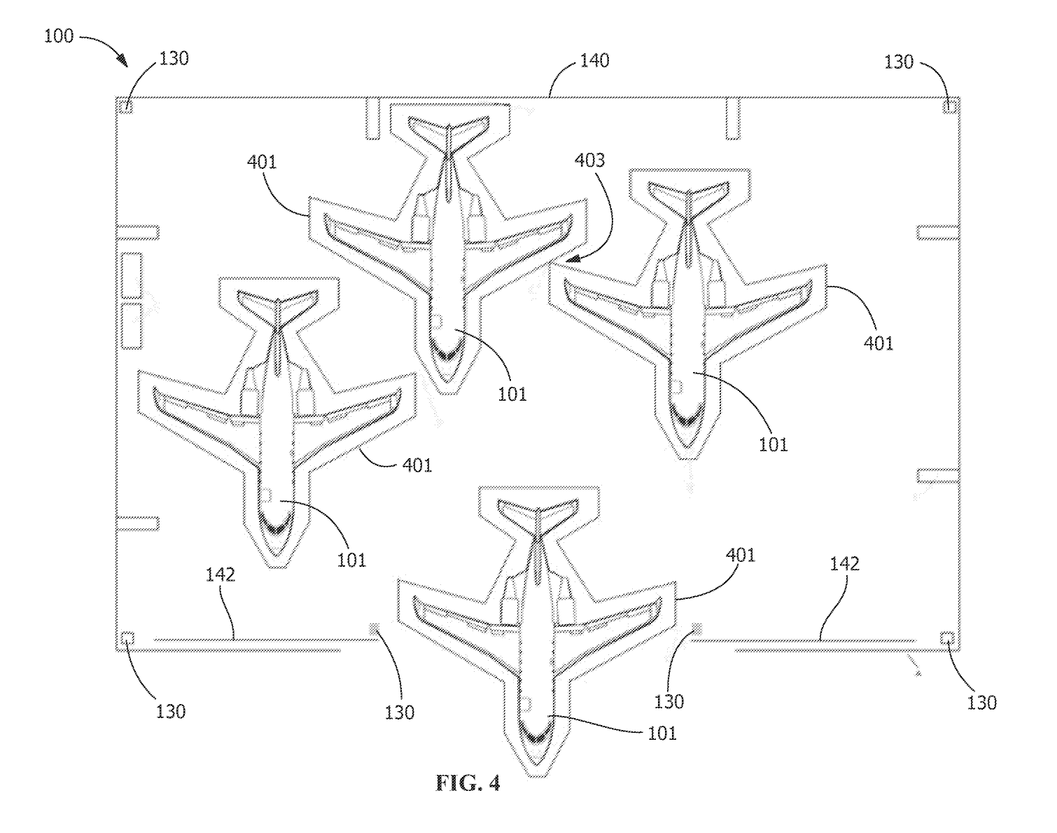

Referring to FIG. 4, in one embodiment, the system 100 includes a virtual collision avoidance module. In another embodiment, the virtual collision avoidance module is configured to receive the operational parameters from the sensor(s) 120. In another embodiment, a digital overlay program of the virtual collision avoidance module creates a scaled virtual hangar 400 with real-time aircraft 101 and/or vehicle 103 locations. The virtual collision avoidance module identifies and/or determines the real-time location of each individual aircraft 101 and/or vehicle 103 based upon the operational parameters received from the sensor(s) 120. Additionally or alternatively, the aircrafts 101, the vehicles 103, and/or other objects within the scaled virtual hangar 400 may be manually identified through user input. Once the aircrafts 101 and/or vehicles 103 have been identified, the virtual collision avoidance module assigns and/or generates a virtual perimeter 401 around each individual aircraft 101 and/or vehicle 103. The virtual perimeter 401 may be automatically set by the virtual collision avoidance module and/or the virtual perimeter 401 may be manually assigned and/or adjusted through user input. For example, after the virtual perimeter 401 is automatically or manually assigned to the aircraft 101 and/or vehicle 103, a user may modify the shape and/or size of the virtual perimeter 401 to adjust an amount of clearance around one or more aircrafts 101 and/or vehicles 103.

As the aircrafts 101 and/or vehicles 103 are physically moved, the virtual collision avoidance module continuously monitors their real-time position and generates an alert when a potential collision is detected. Potential collisions are determined by the virtual collision avoidance module based upon proximity of the aircrafts 101 and/or vehicles 103, proximity of one or more virtual perimeters 401 surrounding the aircrafts 101 and/or vehicles 103, overlap 403 of one or more virtual perimeters 401, a speed and/or trajectory of one or more aircrafts 101 and/or vehicles 103, or a combination thereof. For example, the virtual collision avoidance module may be configured to generate the alert when one or more of the aircrafts 101 and/or vehicles 103 are approaching a wall of the storage facility 140, a structure within the storage facility 140, the hangar door 142, equipment or other articles, other aircrafts 101 and/or vehicles 103, or a combination thereof. Additionally or alternatively, the virtual collision avoidance module may be configured to disable movement of and/or shut off the tow vehicle 105 or other equipment involved in movement of the aircraft 101 before a collision occurs.

In one embodiment, the system 100 includes or is run through a wireless network and/or remote server. The wireless network and/or remote server facilitates control over multiple movements and/or storage locations using a single system 100. Additionally, the wireless network and/or remote server facilitates simultaneous updates to multiple systems 100 and/or system components. In another embodiment, the system 100 is coupled to a database. The database is configured to receive and store operating parameters, certification information, and/or any other information related to the ground transportation and/or storage. For example, the database may store information regarding each of the individuals 203 involved in the ground transportation, such as, but not limited to, their operational privileges, work history, assigned marker(s) 130, or a combination thereof. In another example, the marker(s) 130 are linked to the database, providing a listing of operational privileges and facilitating remote changes to the operating privileges assigned to one or more of the marker(s) 130.

The database is also configured to store information relating to each tow operation that occurs, both successfully and unsuccessfully. In one embodiment, storing the information relating to each tow includes logging the parameters associated with each movement, such as, but not limited to, the individual 203 that operated the tow vehicle 105, the individual 203 who acted as wing walker for the aircraft 101, the tow vehicle 105 that was used, the storage facility 140 that was used, the tow member 303, registration of the aircraft 101 that was moved, position of the hangar doors 142, condition of the lights, or a combination thereof. In another embodiment, the database stores video backups of each movement maintained in the database. In a further embodiment, the system 100 makes a special notation and/or separately records a video backup for a movement that was not allowed to occur based on any condition not being met or an unsafe condition occurring during the movement. This information facilitates determination of existing human error factors and/or insurance evaluations.

In certain embodiments, the system 100 limits information access based upon a set user level. For example, in another embodiment, the system 100 sets one or more super users capable of scheduling and/or modifying operational parameters, overriding parameters, or a combination thereof. In a further embodiment, any individual 203 associated with a specific aircraft 101 is provided access to a full list of details of each movement involving the specific aircraft 101. The details of each movement include, but are not limited to, employee records for the individuals that handled the aircraft 101, information regarding the vehicle 103 that moved the aircraft 101, information regarding the storage facility 140 in which the aircraft 101 was housed, or a combination there. In some embodiments, access to the full list of details excludes access to video of the movements.

Additionally or alternatively, the system 100 includes a daily scheduling feature for predetermined variations in parameters based upon, for example, date and/or time. One predetermined variation in the parameters includes configurations for night operations or holiday operations, such as relaxed wing walker parameters, tighter tolerances for light, full opening of the hangar doors 142, or a combination thereof. Once the last night or holiday shift ends, the parameters are reset for normal operations.

According to one or more of the embodiments disclosed herein, a method for transportation and/or storage of one or more of the aircrafts 101 includes positioning the ground transportation vehicle 103 relative to the aircraft 101, coupling the ground transportation vehicle 103 to the aircraft 101, un-chocking the aircraft 101, initiating tow operation at or below a predetermined speed, positioning the aircraft 101 in a storage location, such as within the storage facility 140, chocking the aircraft 101, and disconnecting the aircraft 101 from the ground transportation vehicle 103. In another embodiment, coupling the ground transportation vehicle 103 to the aircraft 101 includes direct coupling and/or coupling with the tow member 303. In a further embodiment, after coupling the ground transportation vehicle 103 to the aircraft 101, and based upon the operational parameters received from the sensor(s) 120, the system 100 determines the operational parameters, selects the storage facility 140 for the aircraft 101, sets a ground transportation route for the aircraft, determines the presence and/or positioning of the individuals 203 involved in the movement, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system, comprising:
a control module;
at least one sensor arranged and disposed to measure operational parameter and provide the operational parameters to the control module; and
a ground transport vehicle in communication with the control module;
wherein the ground transport vehicle is arranged and disposed for coupling with an aircraft; and
wherein the control module is arranged and disposed to direct at least one of ground handling of the aircraft and storage of the aircraft.

2. The system of claim 1, wherein the ground transport vehicle is selected from the group consisting of a tow vehicle, a cargo vehicle, a refueling vehicle, a maintenance vehicle, and combinations thereof.

3. The system of claim 1, wherein the at least one sensor is selected from the group consisting of a motion sensor, a proximity sensor, a velocity sensor, a laser topography sensor, a counting switch, a camera, and combinations thereof.

4. The system of claim 1, wherein the at least one sensor is wirelessly coupled to the control module.

5. The system of claim 1, further comprising at least one marker arranged and disposed for detection by the at least one sensor.

6. The system of claim 5, wherein the at least one marker is selected from the group consisting of a fixed positional marker, a radio-frequency identification (RFID) tag, a microchip, a portion of a storage facility, and combinations thereof.

7. The system of claim 5, wherein the control module is arranged and disposed to determine operational parameters based upon the at least one sensor reading the at least one marker.

8. The system of claim 1, further comprising a kill system secured to the ground transport vehicle, the kill system being arranged and disposed to disable movement of the ground transport vehicle.

9. The system of claim 8, wherein the control module is arranged and disposed to remotely operate the kill system.

10. The system of claim 1, wherein the control module is arranged and disposed to define an operational area for the aircraft.

11. The system of claim 10, wherein the at least one sensor is arranged and disposed to detect an object within the operational area.

12. The system of claim 11, wherein the control module is arranged and disposed to disable movement of the ground transport vehicle upon detection of the object within the operational area.

13. The system of claim 1, further comprising a virtual collision avoidance module.

14. The system of claim 13, wherein the virtual collision avoidance module is arranged and disposed to generate a scaled virtual hangar displaying real-time positioning of the aircraft.

15. A system, comprising:
a control module;
at least one sensor arranged and disposed to measure operational parameter and provide the operational parameters to the control module;
at least one marker arranged and disposed for detection by the at least one sensor;
a ground transport vehicle in communication with the control module; and
a kill system secured to the ground transport vehicle;
wherein the ground transport vehicle is arranged and disposed for coupling with an aircraft;
wherein the control module is arranged and disposed to direct at least one of ground handling of the aircraft and storage of the aircraft; and
wherein the kill system is arranged and disposed to disable movement of the ground transport vehicle.

16. A ground transport and storage method, comprising:
providing a system, the system including:
a control module;
at least one sensor arranged and disposed to measure operational parameter and provide the operational parameters to the control module; and
a ground transport vehicle in communication with the control module;
coupling the ground transport vehicle to an aircraft;
communicating the operational parameters from the at least one sensor to the control module;
defining an operational area for the aircraft;
setting a ground transportation route with the control module based upon the operational parameters from the at least one sensor; and
moving the aircraft with the ground transport vehicle;
wherein the moving of the aircraft follows the ground transportation route.

17. The method of claim 16, further comprising continuously monitoring for an object within the operational area.

18. The method of claim 17, further comprising disabling the moving of the aircraft upon detection of the object within the operational area.

19. The method of claim 16, further comprising generating a virtual hangar with a virtual collision avoidance module.

20. The method of claim 19, wherein generating the virtual hangar comprises determining real-time positioning of the aircraft and generating a virtual perimeter around the aircraft.
